(19) United States
(12) Patent Application Publication
(10) Pub. No.: US 2022/0333725 A1
(43) Pub. Date: Oct. 20, 2022

(54) HOSE SYSTEM HAVING MEANS FOR DETECTING THE TEMPERATURE INSIDE THE HOSE

(71) Applicant: ContiTech Schlauch GmbH, Hannover (DE)

(72) Inventor: Alexander Schmidt, Goettingen (DE)

(73) Assignee: ContiTech Schlauch GmbH, Hannover (DE)

(21) Appl. No.: 17/753,432

(22) PCT Filed: Aug. 21, 2020
(86) PCT No.: PCT/EP2020/073483

§ 371 Date: Mar. 2, 2022

(30) Foreign Application Priority Data
Sep. 2, 2019 (DE) 10 2019 213 235.9

(51) Int. Cl. F16L 55/00; F16L 11/00; G01K 13/02; G01K 7/18; G01K 1/14

(52) U.S. Cl. CPC F16L 55/00; F16L 11/00; G01K 13/02; G01K 7/18; G01K 1/14

(57) ABSTRACT

Presented and described is a hose system, having a hose (1) that extends between a first and a second end (3, 7), wherein the hose (1) has a wall (9), wherein a conductor element (11) is recessed in the wall (9) and extends between the first and the second end (3, 7), wherein the conductor element (11) is formed from an electrically conductive material having a temperature-dependent specific resistance, and wherein the conductor element (11) has a first electrical connection (19) and a second electrical connection (21) that are spaced apart along the conductor element (11), and having a measuring device (23) that is connected to the first and to the second electrical connection (19, 21) and is designed to generate an output signal from an electrical signal that is detected between the first and the second electrical connection (19, 21), which output signal is a measure of the electrical resistance of the conductor element (11) between the first electrical connection (19) and the second electrical connection (21).

The present invention relates to a hose system having means for detecting the temperature in the hose interior.

It is known from the prior art to provide sensors in the wall of a hose, which sensors can be used to determine the temperature in the interior of a hose. For example, it is known from EP 2 434 195 A1 to guide along the hose wall two wires which are made of different materials and the ends of which are connected together, in order to form a thermocouple. To determine the temperature in the hose, the thermovoltage between the two wires is measured. Such a set-up is complicated to install, and it also determines the temperature in the area surrounding the connection between the two wires, rather than averaging the temperature along the entire length of the hose.

It is also known, for example, to provide RFID chips in the wall of the hose that are connected to a temperature sensor. However, this has the disadvantage that the chips with the sensors are difficult to insert into the wall of the hose. In particular, such insertion is complicated to integrate into the conventional production process. In particular, the problem arises that the RFID chips represent a weak point in the hose due to the dimensions of the chip together with the sensor and antenna and can form the starting point for cracks in the hose.

However, it is often necessary to determine the temperature of the medium in the hose interior. On the one hand, this can be relevant during normal operation in order to monitor whether or not the hose is exposed to excessive thermal loads during operation. Furthermore, it may also be necessary, especially in the food sector, to monitor the temperature of the hose interior during a cleaning process to ensure that a certain minimum temperature has been reached in the interior of the hose during cleaning. Lastly, monitoring the thermal load allows conclusions to be drawn about the remaining service life of the hose.

With this in mind, it is the object of the present invention to provide a hose system which makes it possible to detect the temperature in the interior of the hose and which is easy to produce.

This object is achieved by a hose system having the features of claim 1.

On the one hand, the hose system according to the invention comprises a hose that extends between a first and a second end, wherein the hose has a wall, and wherein a conductor element is recessed in the wall and in turn extends between the first and the second end. The conductor element is formed from an electrically conductive material having a temperature-dependent specific resistance, wherein the conductor element has a first electrical connection and a second electrical connection that are spaced apart along the conductor element.

On the other hand, the hose system according to the invention has a measuring device that is connected to the first and to the second electrical connection on the conductor element and that is designed to generate an output signal from an electrical signal that is detected between the first and the second electrical connection by the measuring device, which output signal is a measure of the electrical resistance of the conductor element between the first electrical connection and the second electrical connection.

The hose system according to the invention takes advantage of the fact that the resistance of the conductor element that extends in the wall of the hose changes according to the temperature. This change in resistance is detected with the aid of the measuring device, wherein this first outputs a signal that is a measure of the resistance of the conductor element, so that the temperature in the interior of the hose can in turn be concluded from this signal.

The conductor element can be inserted easily into the wall of the hose, wherein it is not necessary to provide an additional production step. Rather, the insertion of the conductor element can be integrated into the conventional production of a hose.

Lastly, the embodiment according to the invention has the advantage that the change in resistance between the first electrical connection and the second electrical connection means that the temperature is detected averaged over the region between the two connections. As a result, the hose system according to the invention makes it possible to detect the temperature not only at a specific point, but rather it is necessarily averaged over a larger region, so that measurement artifacts can be avoided.

In the hose system according to the invention, it is furthermore not necessary that the conductor element extends in a straight line between the first end of the hose and its second end. In particular, it is conceivable that the conductor element runs helically along the hose wall and/or that the conductor element runs in a plurality of portions from the first end firstly to the second end, then back to the first end and possibly even back to the second end. It is thus open as to where the first electrical connection and the second electrical connection are provided. By allowing the conductor element to extend in a plurality of portions between the first and the second end of the hose, it is also conceivable that the connections are provided at one end of the hose. The invention is not however restricted to such an arrangement. Rather, it may initially be left open as to how far apart the electrical connections are spaced from one another along the conductor element.

In a preferred embodiment, the measuring device of the hose system according to the invention is designed in such a way that a temperature signal is generated from the output signal and is a measure of the temperature of the conductor element between the first and the second electrical connection. In particular, the measuring device can be designed to calculate from the output signal, which is a measure of the resistance, a signal that is proportional to the temperature, so that the temperature can be indicated, for example on a display. Furthermore, when determining the temperature signal, it can also be taken into account that the conductor element is recessed in the wall of the hose and therefore the temperature of a fluid in the hose is only indirectly detected. In order to obtain a signal that is a measure of the behavior of the temperature of the fluid in the hose, the heat conduction properties of the layers of the hose can also be taken into account when determining the temperature signal.

Furthermore, it is preferred if the conductor element is wire-shaped. This means that the conductor element has a much larger dimension in the direction of extension than in the direction perpendicular thereto. Wire-shaped material can be inserted easily into the wall of a hose.

In a further preferred manner, the conductor element is formed as a steel coil which preferably extends helically in the wall of the hose.

Alternatively, however, in another preferred embodiment, it is also possible for the conductor element to be designed as a braid that is inserted into the wall of the hose. In this case, the conductor element not only serves to detect the temperature, but also simultaneously assumes the function of increasing the pressure resistance of the hose.

Furthermore, it is preferred if the conductor element is designed as a reinforcement element, so that the wall of the hose is stiffened and the hose has a stability under negative pressure, relative to room temperature, of more than −0.5 bar (rel.) and further preferably of up to −0.95 bar (rel.). Thus, if the pressure in the environment is greater than in the hose interior, the hose will then not collapse but will substantially retain its cross-sectional shape so that medium can continue to flow through the hose.

In such an embodiment, the conductor element not only serves to detect the temperature in the hose interior via its change in resistance, but also has a reinforcing function at the same time. Thus, two functions can be achieved simultaneously by one and the same element, which makes the hose design according to the invention particularly cost-effective.

It is further preferred that the conductor element has a first and a second portion, wherein both the first portion and the second portion extend from the first to the second end of the hose, wherein the first portion and the second portion are electrically connected to each other in the region of the first end, and wherein the first electrical connection is formed at the end of the first portion that is located at the second end of the hose and the second electrical connection is formed at the end of the second portion that is formed at the second end of the hose.

In this embodiment, the two portions of the conductor element are short-circuited to each other at the first end of the hose, and the two electrical connections are then provided at the second end. It is then not necessary to provide electrical connections in the wall remotely from the ends of the hose, and instead both connections can be formed at one end, where a coupling element for the hose is possibly also provided, which simplifies the connection of the hose to the measuring device. In addition, the resistance can then be detected over twice the length of the hose, so that the resistance is determined over a large length, which in turn leads to a high measurement accuracy with respect to the temperature.

Furthermore, in a preferred embodiment, the wall of the hose can comprise an inner layer and an outer layer, wherein the inner layer adjoins or delimits the hose interior, and wherein the outer layer bears against the side of the inner layer facing away from the hose interior. Further, the conductor element is arranged between the inner layer and the outer layer. With such a set-up, production is particularly simplified because it is only necessary to insert the conductor element between the layers, which can be easily integrated in a conventional production process. It should be noted here that both the inner layer and the outer layer themselves can in turn have a multilayer structure.

In particular, the outer layer and the inner layer can each be formed by a helically wound strip, so that the conductor element can be integrated in a simple manner in a so-called wound hose. However, it is also possible that the inner layer and/or the outer layer are extruded, so that combinations of wound and extruded layers are also possible.

Furthermore, it is preferred if the measuring device additionally has a further temperature sensor which is designed to detect the temperature of the environment of the hose. This enables the measuring device to be calibrated in a simple manner if the interior of the hose also has an ambient temperature. Then, the temperature detected via the conductor element and the ambient temperature detected by the temperature sensor must be identical, which can serve as a basis for calibration.

Lastly, it is preferred if the measuring device has a transmission device configured to wirelessly transmit to a receiving device a signal containing information indicating the resistance between the first electrical connection and the second electrical connection. This information can also include the temperature in the interior of the hose.

In this way, it is possible for temperatures in the hose interior detected by means of the measuring device to be transmitted wirelessly to a central control system, which has a receiving device.

In the following, the present invention is explained with reference to a drawing showing only preferred exemplary embodiments of the present invention, wherein

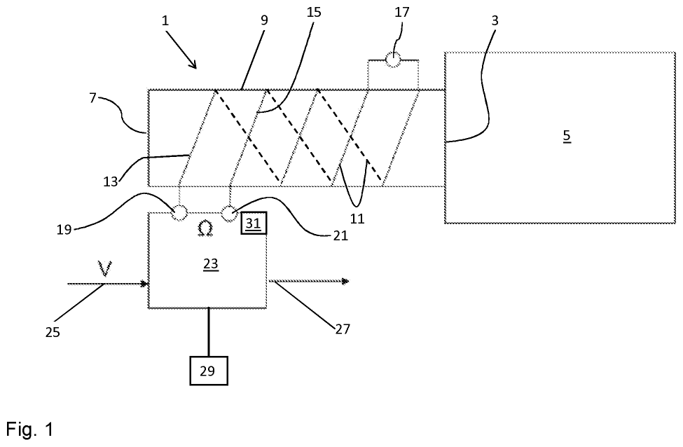

FIG. 1 is a schematic illustration of a preferred exemplary embodiment of a hose system according to the invention,

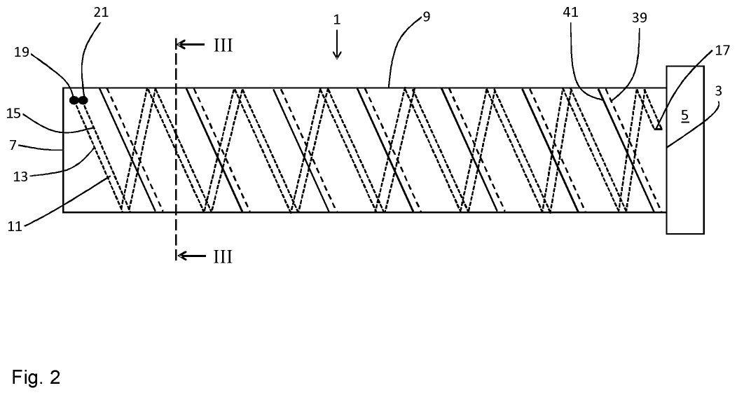

FIG. 2 is a schematic side view of a preferred exemplary embodiment of a hose that is part of a hose system according to the invention, and

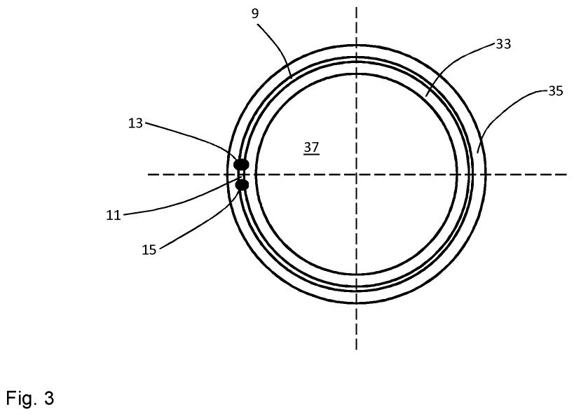

FIG. 3 shows a cross-sectional view of the preferred exemplary embodiment of a hose from FIG. 2.

FIG. 1 shows an exemplary embodiment of a hose system according to the invention, wherein this has a hose 1 which, in the exemplary embodiment described here, is provided with a connection element 5 at a first end 3. The second end 7 of the hose 1, on the other hand, is designed here as an open end, but can likewise be provided with a connection element. The hose 1 thus extends between the first end 3 and the second end 7. As further shown schematically, the hose 1 has a wall 9 which delimits a hose interior.

As can further be seen from the schematic illustration in FIG. 1, the wall 9 has a conductor element 11 which is recessed in the wall 9 and, in the exemplary embodiment shown here, comprises a first portion 13 and a second portion 15, both of which run helically along the wall 9. While in the preferred exemplary embodiment described here, the conductor element 11 or the portions 13, 15 forming it run helically, other courses can also be selected. For example, it is also conceivable that the conductor element runs in a straight line along the direction in which the hose extends.

The conductor element 11 is formed of an electrically conductive material, such as metal or steel, wherein the material of the conductor element 11 has a temperature-dependent specific resistance such that the resistance of the conductor element 11 changes as the temperature of a medium flowing through the interior of the hose 1 changes.

If the conductor element 11 is designed as a steel coil running helically along the wall 9 of the hose 1, the conductor element 11 can also form a reinforcement element so that the wall 9 is stiffened and the hose 1 retains its cross-sectional shape in the event of a pressure difference between the environment of the hose and the hose interior. Preferably, the hose 1 has a stability under negative pressure, relative to room temperature, of more than −0.5 bar (rel.) and further preferably of up to −0.95 bar (rel.). Then, the conductor element 11, which is designed as a reinforcement element, prevents the hose from collapsing in the event of negative pressure in the interior.

As can be further seen in FIG. 1, the portions 13, 15 of the conductor element 11 run substantially parallel to each other in a helical manner between the first end 3 and the second end 7 of the hose 1. Here, it can be seen that the first portion 13 and the second portion 15 are electrically connected to each other in the region of the first end 3 at a contact point 17 shown schematically, while a first electrical connection 19 and a second electrical connection 21 are provided at the ends of the first portion 13 and the second portion 15 which are arranged adjacently to the second end 7 of the hose 1.

As can be further seen in FIG. 1, the exemplary embodiment of a hose system according to the invention has a measuring device 23 that is connected to the first electrical connection 19 and the second electrical connection 21 of the conductor element 11. The measuring device 23 is designed to generate an output signal from an electrical signal that is detected between the first and the second electrical connection 19, 21, which output signal is a measure of the electrical resistance of the conductor element 11 between the first electrical connection 19 and the second electrical connection 21.

In the preferred exemplary embodiment shown here, the conductor element 11 has the first portion 13 and the second portion 15 connected to each other adjacently to the first end of the hose 1, so that between the first electrical connection 19 and the second electrical connection 21 the total resistance of the conductor element 11 consisting of the first portion 13 and the second portion 15 can be determined. Due to the fact that the resistance of the entire conductor element 11 is detected here, even small temperature-related changes in the specific resistance caused by only a small temperature change of the fluid in the interior of the hose 1 can be reliably detected, since the absolute resistance changes to the greatest possible extent due to the large length of the conductor element 11.

In a preferred exemplary embodiment, the signal that is a measure of the electrical resistance of the conductor element 11 between the electrical connections 19, 21 can be a voltage signal that is obtained by means of a measuring bridge in which the resistance of the conductor element 11 between the connections 19, 21 is a partial resistance in the measuring bridge. However, other possibilities are also conceivable for generating the output signal which forms a measure of the electrical resistance.

The measuring device 23 is additionally connected to a voltage supply 25, for example to supply voltage to the electronics for the measuring bridge. It is additionally preferred if the measuring device 23 is configured to generate a temperature signal which is output at an interface 27 and which is a measure of the temperature of the conductor element 11. This can be either an analog voltage signal or a digital signal. Other possibilities are likewise conceivable. It is also conceivable that a display (not shown) is provided on the measuring device 23, on which display the temperature of the conductor element 11 is indicated.

Furthermore, the preferred exemplary embodiment of a hose system 1 shown here has a temperature sensor 29 on the measuring device 23, by means of which sensor the temperature in the environment of the hose system can be detected. This temperature sensor 29 is used to calibrate the system, wherein this can be done in such a way that when the hose interior and the environment have the same temperature, the signal of the temperature sensor 29 is detected by the measuring device 23 and is compared with the signal detected at the connections 19, 21 in such a way that this signal corresponds to the detected ambient temperature.

Lastly, the measuring device 23 of the preferred exemplary embodiment of a hose system shown here can be provided with a transmission device 31 configured to wirelessly transmit a signal to a receiving device located remotely from the hose system, wherein this signal contains information indicating the resistance between the first electrical connection and the second electrical connection, or the temperature of the conductor element 11 determined therefrom.

With the hose system 1 according to the invention, it is possible in a simple manner to determine the temperature in the hose interior without having to install sensor devices inside the wall 9 in a complicated manner. Rather, it is perfectly sufficient to insert the electrical conductor in the wall during the production process, wherein, if the connections are provided at the end, a simple connection to the measuring device 23 is made possible.

In the present exemplary embodiment, the conductor element 11 has been described as being wire-shaped. However, it is also conceivable that the conductor element 11 is formed as a braid.

FIGS. 2 and 3 show a preferred exemplary embodiment of a hose 1 of a hose system according to the invention, wherein in the exemplary embodiment shown here the wall 9 of the hose 1 has an inner layer 33 and an outer layer 35, wherein the inner layer 33 delimits the hose interior 37, while the outer layer 35 surrounds the inner layer 33 and also bears against the inner layer 33.

In the exemplary embodiment described here, the inner layer 33 and the outer layer 35 are formed as homogeneous single layer. However, it is also conceivable that the inner layer and/or the outer layer are multi-layered.

Furthermore, between the outer layer 35 and the inner layer 33, the conductor element 11 is arranged, which, as can be seen in FIG. 2, is again formed from a first and a second portion 13, 15, which run helically and parallel to each other in the wall 9. As already described in conjunction with FIG. 1, the first portion 13 and the second portion 15 of the conductor element 11 are short-circuited to each other adjacently to the first end of the hose 1 at a contact point 17, while adjacently to the second end 7 of the hose 1 the first electrical connection 19 and the second electrical connection 21 are provided, via which the hose 1 can be connected to the measuring device 23.

As can be further seen in FIG. 2, this preferred exemplary embodiment of a hose 1 again has a connection element 5 at the first end 3. In addition, the wall 9 of the hose 1 is constructed in such a way that both the inner layer 33 and the outer layer 35 are formed of helically extending strips, wherein the edges 39 of the strips forming the inner layer 33 are arranged offset from the edges 41 present on the strips forming the outer layer 35.

In addition, also in the exemplary embodiment of a hose 1 for a hose system according to the invention shown in FIGS. 2 and 3, the conductor element 11 or the portions 13, 15 forming the same can be formed as a steel coil, so that the conductor element 11 serves as a reinforcement element which provides the hose 1 with stability against collapse when a negative pressure prevails in the hose interior 37 compared to the environment.

In particular, if the inner layer 33 and the outer layer 35 are formed from helically arranged strips, the conductor element 11 in the form of the steel coil can be additionally inserted easily between the inner layer 33 and the outer layer 35 during production, so that no additional production steps are necessary compared to a conventional hose with a reinforcement element in order to allow temperature measurement. It is then only necessary, after the actual production of the hose 1, to short-circuit the two portions 11, 15 to one another at one end and to provide the first electrical connection 19 and the second electrical connection 21 at the other end 7. The invention thus makes it possible to provide a temperature measurement in a hose in a simple manner.

### LIST OF REFERENCE SIGNS

1 hose
3 first end
5 connection element
7 second end
9 wall
11 conductor element
13 first portion
15 second portion
17 contact point
19 first electrical connection
21 second electrical connection
23 measuring device
25 voltage supply
27 interface
29 temperature sensor
31 transmission device
33 inner layer
35 outer layer
37 hose interior

1.-12. (canceled)

13. A hose system comprising:
a hose that extends between a first and a second end;
the hose has a wall;
a conductor element recessed in the wall and extends between the first and the second end;
the conductor element formed from an electrically conductive material having a temperature-dependent specific resistance;
the conductor element has a first portion and a second portion that parallel to each other in a helical manner;
the conductor element has a first electrical connection to the first portion and a second electrical connection to the second portion that are spaced apart along the conductor element;
the conductor element is formed as a reinforcement element;
a measuring device connected to the first and to the second electrical connection and designed to generate an output signal from an electrical signal that is detected between the first and the second electrical connection, the output signal is a measure of the electrical resistance of the conductor element between the first electrical connection and the second electrical connection;
the measuring device configured to generate a temperature signal from the output signal.

14. The hose system of claim 13, the wall of the hose is stiffened and the hose retains its cross-sectional shape in the event of a pressure difference between an environment of the hose and the hose interior and has a stability under negative pressure, relative to room temperature, of more than −0.5 bar (rel.) and further preferably of up to −0.95 bar (rel.).

15. The hose system of claim 13, the first portion and the second portion are electrically connected to one another in the region of the first end, and
the first electrical connection is formed at the end of the first portion that is located at the second end of the hose and the second electrical connection is formed at the end of the second portion that is formed at the second end of the hose.

16. The hose system of claim 13,
the wall has an inner layer and an outer layer,
the inner layer delimits the hose interior,
the outer layer bears against the side of the inner layer facing away from the hose interior, and
the conductor element is arranged between the inner layer and the outer layer.

17. The hose system of claim 13, the measuring device having a temperature sensor for detecting an environment temperature of the hose.

18. The hose system of claim 17, the measuring device having a transmission device configured to wirelessly transmit to a receiving device a signal containing information indicating the resistance between the first electrical connection and the second electrical connection.
